(19) United States
(12) Patent Application Publication
(10) Pub. No.: US 2011/0141510 A1
(43) Pub. Date: Jun. 16, 2011

(54) SYSTEM AND METHOD FOR INTELLIGENT ROUTING OF SCAN FILES

(76) Inventors: Man M. GARG, Bellevue, WA (US); Sankarshana MADHAVARAO, Bangalore (IN)

(21) Appl. No.: 12/635,080

(22) Filed: Dec. 10, 2009

(51) Int. Cl. G06F 3/12; G06F 3/048

(52) U.S. Cl. 358/1.15; 715/810

(57) ABSTRACT

The subject application is directed to a system and method for intelligent routing of scan files. Scan data is received from a scan of an associated tangible document from a scanner and character data is extracted via optical character recognition. Data corresponding to a plurality of preselected character sets is stored in memory, each character set associated with at least one routing option set, each routing option set including at least one data routing option stored associatively therewith. Extracted character data is compared to the character sets so as to output at least one corresponding routing option. At least one visual element corresponding to the routing option is displayed on a display and selection data corresponding to the displayed element is received from a user via a user input. A selected routing option received from the associated user is isolated and the scan data is routed to a destination in accordance with received selection data.

### BACKGROUND OF THE INVENTION

The subject application is directed generally to intelligently routing scanner input. The application is particularly applicable to assisting users in routing scanner input to destinations likely to be associated with particular content being scanned.

Scanners are in widespread use in many document processing environments, including offices, factories, schools, retail centers, and medical facilities. Scanners function by receiving tangible media, such as text, pictures, graphs, or composite renderings thereof, and return a digitized version thereof. This digitized version can be used for forming a copy, e-mailing, storage, or facsimile transmission.

When a user inputs a scan, the user must choose one or more destinations for the scan data from a myriad of possible destinations. This is a time consuming process, which is particularly bothersome when many scans must be routed or when many users are waiting to use a shared scan device.

### SUMMARY OF THE INVENTION

In accordance with one embodiment of the subject application, there is provided a system and method for intelligent routing of scan files. Scan data is received from a scan of an associated tangible document from an associated scanner and character data is extracted via optical character recognition. Data corresponding to a plurality of preselected character sets is stored in an associated memory, each character set being associated with at least one routing option set of a plurality thereof, each routing option set including at least one data routing option stored associatively therewith. Extracted character data is compared to the plurality of character sets so as to output at least one routing option corresponding thereto. A visual element, such as an icon or other visual indicia, corresponding to the at least one routing option is displayed on an associated display and selection data corresponding to the at least one displayed visual element is received from an associated user via a user input. At least one selected routing option received from the associated user is isolated and the scan data is routed to at least one destination in accordance with received selection data.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of an intelligent routing assistant system for scan files, operable on a digital computer including a processor according to one embodiment of the subject application;

FIG. 2 is a block diagram illustrating device hardware for use in the intelligent routing assistant system for scan files, operable on a digital computer including a processor according to one embodiment of the subject application;

FIG. 3 is a functional diagram illustrating the device for use in the intelligent routing assistant system for scan files, operable on a digital computer including a processor according to one embodiment of the subject application;

FIG. 4 is a block diagram illustrating controller hardware for use in the intelligent routing assistant system for scan files, operable on a digital computer including a processor according to one embodiment of the subject application;

FIG. 5 is a functional diagram illustrating the controller for use in the intelligent routing assistant system for scan files, operable on a digital computer including a processor according to one embodiment of the subject application;

FIG. 6 is a functional diagram illustrating a server for use in the intelligent routing assistant system for scan files, operable on a digital computer including a processor according to one embodiment of the subject application;

FIG. 7 is a functional diagram illustrating a workstation for use in the intelligent routing assistant system for scan files, operable on a digital computer including a processor according to one embodiment of the subject application;

FIG. 8 is a block diagram illustrating the intelligent routing assistant system for scan files, operable on a digital computer including a processor according to one embodiment of the subject application;

FIG. 9 is a functional diagram illustrating the intelligent routing assistant system for scan files, operable on a digital computer including a processor according to one embodiment of the subject application;

FIG. 10 is a flowchart illustrating an intelligent routing assistant method for scan files, operable on a digital computer including a processor according to one embodiment of the subject application; and

FIG. 11 is a flowchart illustrating an intelligent routing assistant system for scan files, operable on a digital computer including a processor according to one embodiment of the subject application.

### DETAILED DESCRIPTION OF THE PREFERRED EMBODIMENT

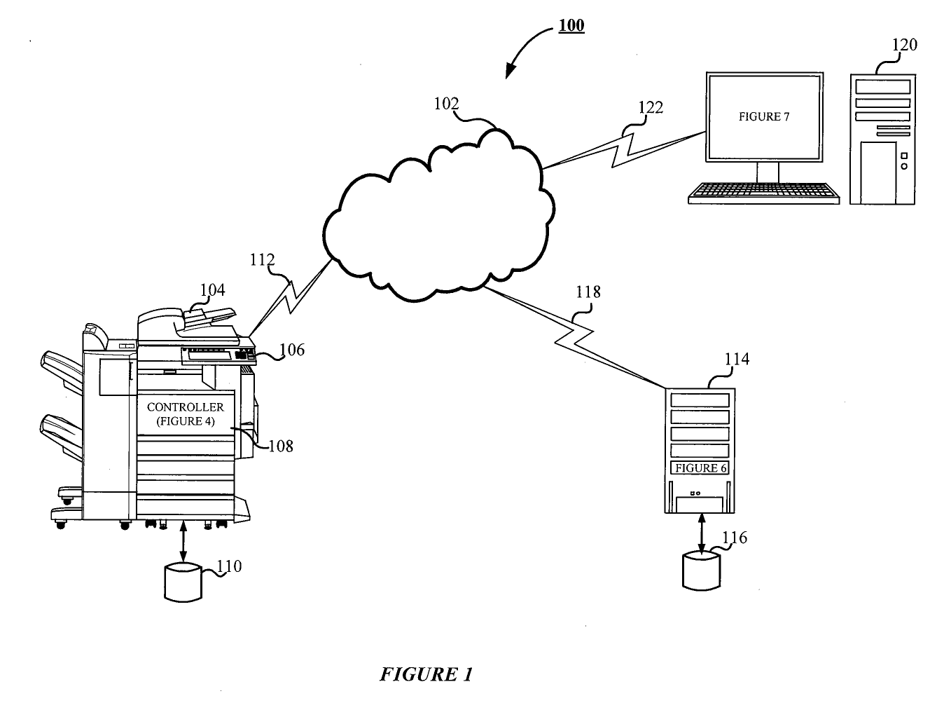

The subject application is directed to a system and method for intelligently routing scanner input. In particular, the subject application is directed to a system and method for assisting users in routing scanner input to destinations likely to be associated with particular content being scanned. More particularly, the subject application is directed to a system and method that is applicable to intelligently routing scan files based upon preselected characters resident in the files. It will become apparent to those skilled in the art that the system and method described herein are suitably adapted to a plurality of varying electronic fields employing file routing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of an intelligent routing assistant system 100 for scan files, operable on a digital computer including a processor in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

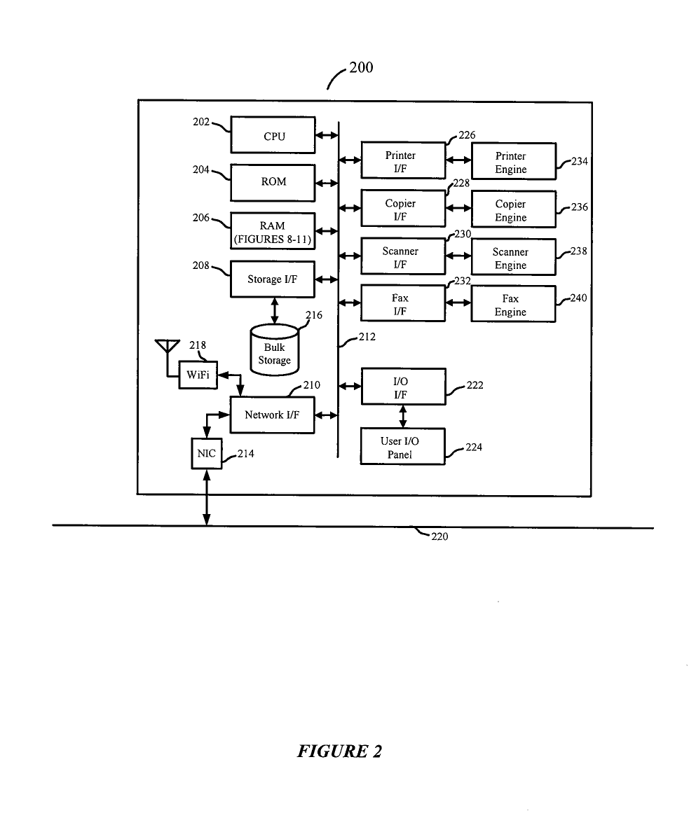

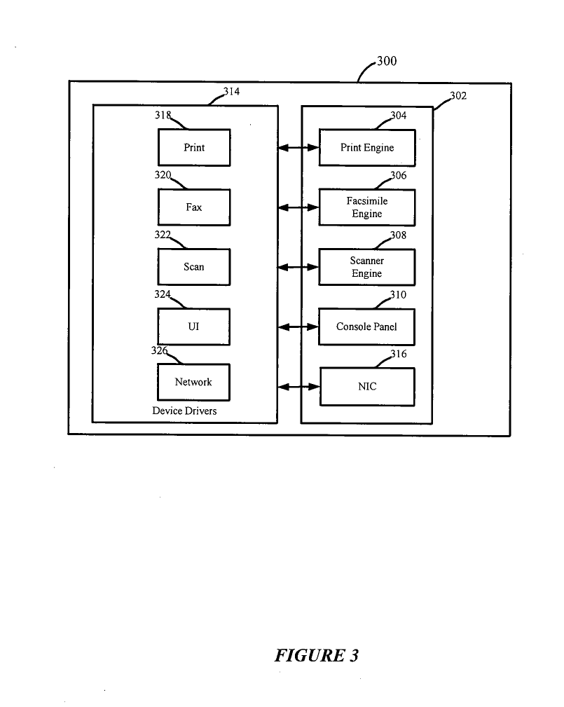

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

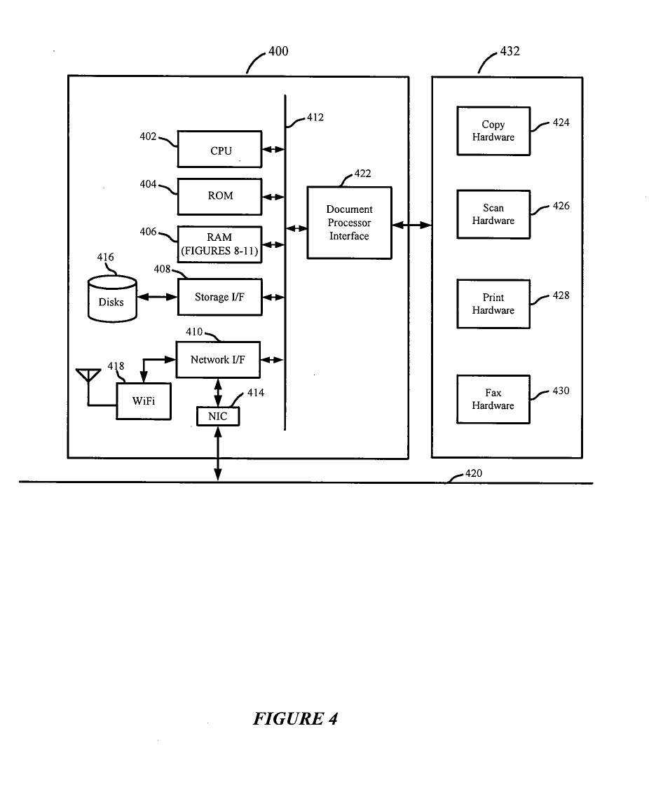

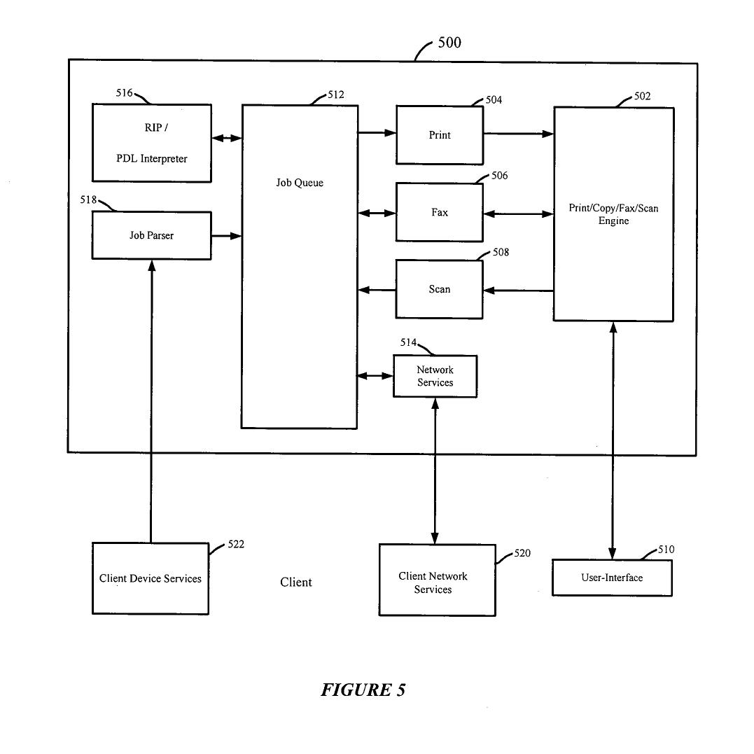

In accordance with one embodiment of the subject application, the document processing device 104 incorporates a backend component, designated as the controller 108, and suitably adapted to facilitate the operations of the document processing device 104, as will be understood by those skilled in the art. Preferably, the controller 108 is embodied as hardware, software, or any suitable combintion thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the intelligent routing assistant system and method for scan files, operable on a digital computer including a processor of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, character set data, user-supplied data fields, modified image data, redacted data, user information, cellular telephone data, document processing instructions, graphical user interface data, customer information, workflow data, payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like.

The system 100 illustrated in FIG. 1 further depicts a backend component, shown as the server 114, in data communication with the computer network 102 via a communications link 118. It will be appreciated by those skilled in the art that the server 114 is shown in FIG. 1 as a component of the system 100 for example purposes only, and the subject application is capable of implementation without the use of a separate backend server component, e.g. the server 114 is capable of implementation via the document processing device 104, or via an administrative device 120. The skilled artisan will appreciate that the server 114 comprises hardware, software, and combinations thereof suitably adapted to provide one or more services, web-based applications, storage options, and the like, to networked devices. In accordance with one example embodiment of the subject application, the server 114 includes various components, implemented as hardware, software, or a combination thereof, for managing retention of secured documents, text data, performing searches, comparisons, maintaining database entries, account information, receiving payment data, retrieval of documents, and the like, which are accessed via the computer network 102.

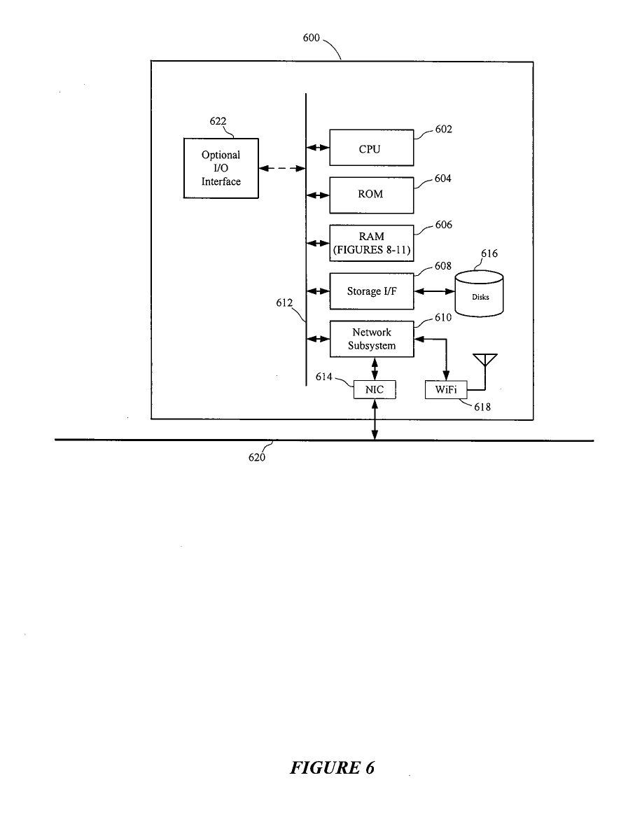

The communications link 118 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 114 are capable of implementation on any suitable computing device coupled to the computer network 102, e.g. the controller 108, or the like. The functioning of the server 114 will better be understood in conjunction with the block diagram illustrated in FIG. 6, explained in greater detail below.

Communicatively coupled to the server 114 is the data storage device 116. According to the foregoing example embodiment, the data storage device 116 is any mass storage device, or plurality of such devices, known in the art including, for example and without limitation, magnetic storage drives, a hard disk drive, optical storage devices, flash memory devices, or any suitable combination thereof. In such an embodiment, the data storage device 116 is suitably adapted to store account information, document processing device identification data, document processing device security level data, update software, policy information, and the like. It will be appreciated by those skilled in the art that while illustrated in FIG. 1 as being a separate component of the system 100, the data storage device 116 is capable of being implemented as an internal storage component of the server 114, or the like, such as, for example and without limitation, an internal hard disk drive, or the like.

Also depicted in FIG. 1 is an administrative device, illustrated as an administrative computer workstation 120 in data communication with the computer network 102 via a communications link 122. It will be appreciated by those skilled in the art that the administrative workstation 120 is shown in FIG. 1 as a workstation computer for illustration purposes only. As will be understood by those skilled in the art, the administrative workstation 120 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the administrative workstation 120 further includes software, hardware, or a suitable combination thereof configured to interact with the document processing device 104, communicate with the server 114, or the like.

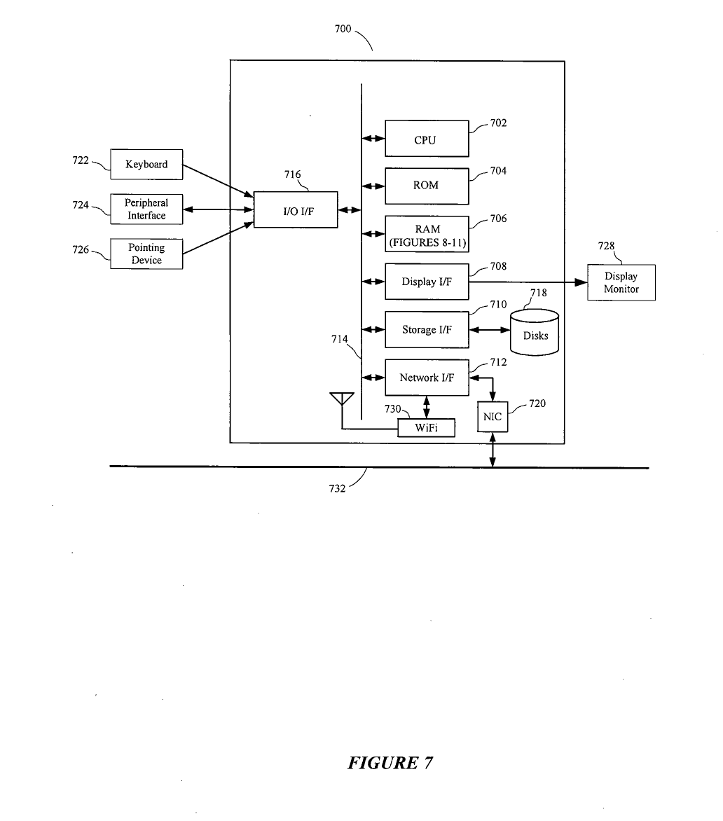

The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative workstation 120 is suitably adapted to provide document data, job data, user interface data, image data, monitor document processing jobs, employ thin-client interfaces, generate display data, generate output data, or the like, with respect to the document processing device 104, or any other similar device coupled to the computer network 102. The functioning of the administrative device 120 will better be understood in conjunction with the block diagram illustrated in FIG. 7, explained in greater detail below.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600 (depicted in FIG. 1 as the server 114), on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

Turning now to FIG. 7, illustrated is a hardware diagram of a suitable workstation 700, shown as the computer workstation 120, for use in connection with the subject system. A suitable workstation includes a processor unit 702 which is advantageously placed in data communication with read only memory 704, suitably non-volatile read only memory, volatile read only memory or a combination thereof, random access memory 706, display interface 708, storage interface 710, and network interface 712. In a preferred embodiment, interface to the foregoing modules is suitably accomplished via a bus 714.

The read only memory 704 suitably includes firmware, such as static data or fixed instructions, such as BIOS, system functions, configuration data, and other routines used for operation of the workstation 700 via CPU 702.

The random access memory 706 provides a storage area for data and instructions associated with applications and data handling accomplished by the processor 702.

The display interface 708 receives data or instructions from other components on the bus 714, which data is specific to generating a display to facilitate a user interface. The display interface 708 suitably provides output to a display terminal 728, suitably a video display device such as a monitor, LCD, plasma, or any other suitable visual output device as will be appreciated by one of ordinary skill in the art.

The storage interface 710 suitably provides a mechanism for non-volatile, bulk or long term storage of data or instructions in the workstation 700. The storage interface 710 suitably uses a storage mechanism, such as storage 718, suitably comprised of a disk, tape, CD, DVD, or other relatively higher capacity addressable or serial storage medium.

The network interface 712 suitably communicates to at least one other network interface, shown as network interface 720, such as a network interface card, and wireless network interface 730, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 720 is interconnected for data interchange via a physical network 732, suitably comprised of a local area network, wide area network, or a combination thereof.

An input/output interface 716 in data communication with the bus 714 is suitably connected with an input device 722, such as a keyboard or the like. The input/output interface 716 also suitably provides data output to a peripheral interface 724, such as a USB, universal serial bus output, SCSI, Firewire (IEEE 1394) output, or any other interface as may be appropriate for a selected application. Finally, the input/output interface 716 is suitably in data communication with a pointing device interface 726 for connection with devices, such as a mouse, light pen, touch screen, or the like.

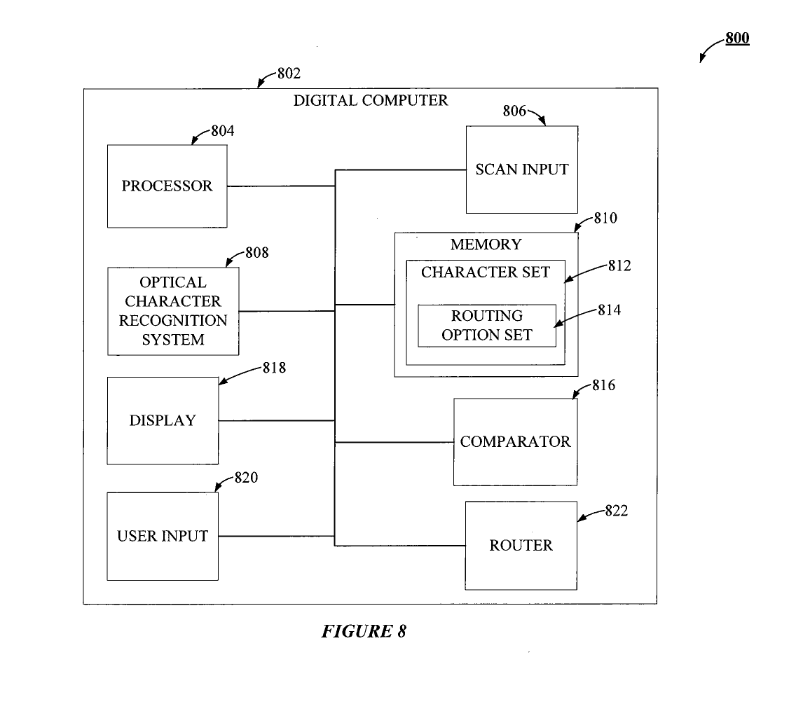

Referring now to FIG. 8, illustrated is a block diagram of an intelligent routing assistant system 800 for scan files, operable on a digital computer 802 that includes a processor 804 in accordance with one embodiment of the subject application. It will be appreciated by those skilled in the art that the digital computer 802 is capable of incorporation as a component of a device, including, for example and without limitation, a server, a document processing device, a workstation, or other suitable document output device. As shown in FIG. 8, the system 800 includes a scan input 806 operable to receive scan data from a scan of an associated tangible document. An optical character recognition system 808 is then implemented to extract character data from received scan data. The system 800 further incorporates memory 810 that includes data corresponding to preselected character sets 812, with each character set 812 associated with at least one routing option set 814. Preferably, each routing option set 814 includes at least one data routing option for routing data to a designated destination.

The system 800 further includes a comparator 816 configured to compare extracted character data to the character sets 812 so as to output at least one routing option corresponding to the comparison. Additionally, the system incorporates a display 818 operable to display at least one visual element corresponding to the one or more routing options and a user input 820 configured to receive selection data from an associated user. Preferably, the selection data corresponds to at least one displayed visual element so as to isolate a selected routing option. The system further employs a router 822 configured to route the scan data to one or more destinations in accordance with the selection data received from the associated user.

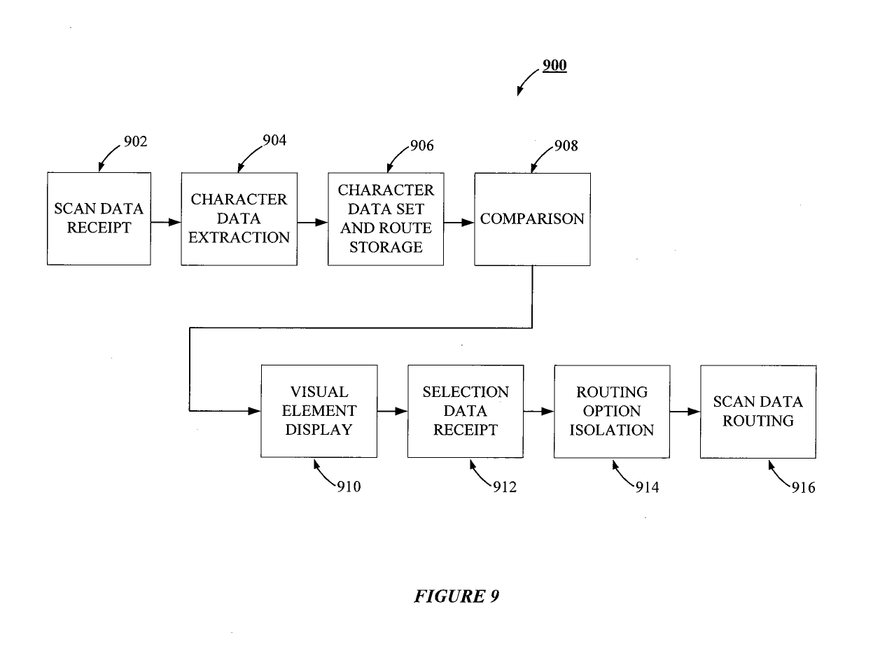

Turning now to FIG. 9, illustrated is a functional diagram of an intelligent routing assistant system 900 for scan files, operable on a digital computer including a processor in accordance with one embodiment of the subject application. As shown in FIG. 9, scan data receipt 902 first occurs of scan data from a scan of an associated tangible document from an associated scanner. Character data extraction 904 is then performed via optical character recognition on the scan data. Character data set and associated routing option set storage 906 is then performed of data corresponding to preselected character sets in an associated memory. In accordance with one embodiment of the subject application, each character set is associated with one or more routing option sets, where each routing option set includes one or more associated data routing options.

A comparison 908 is then performed of the extracted character data with the character sets so as to output one or more corresponding routing options. Visual element display 910 then occurs corresponding to the routing option on an associated display. Next, selection data receipt 912 occurs of selection data corresponding to at least one displayed visual element from an associated user via a user input. Routing option isolation 914 is then performed corresponding to at least one routing option selected by the associated user. Thereafter, scan data routing 916 occurs of the scan data to at least one destination in accordance with received selection data.

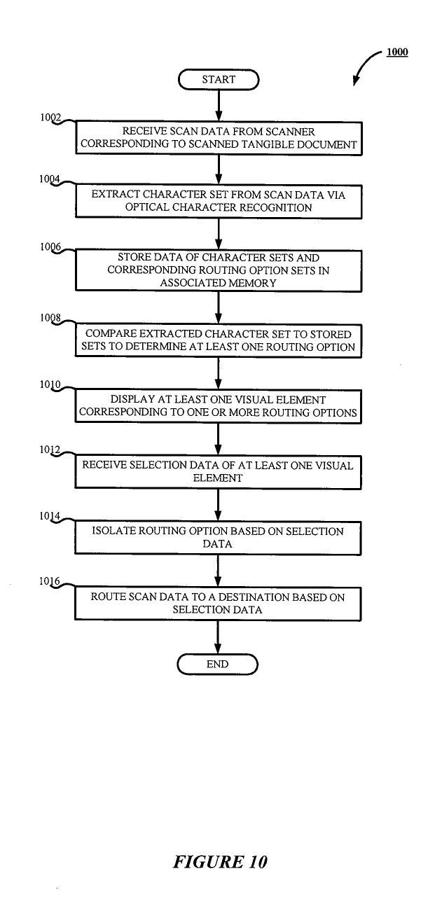

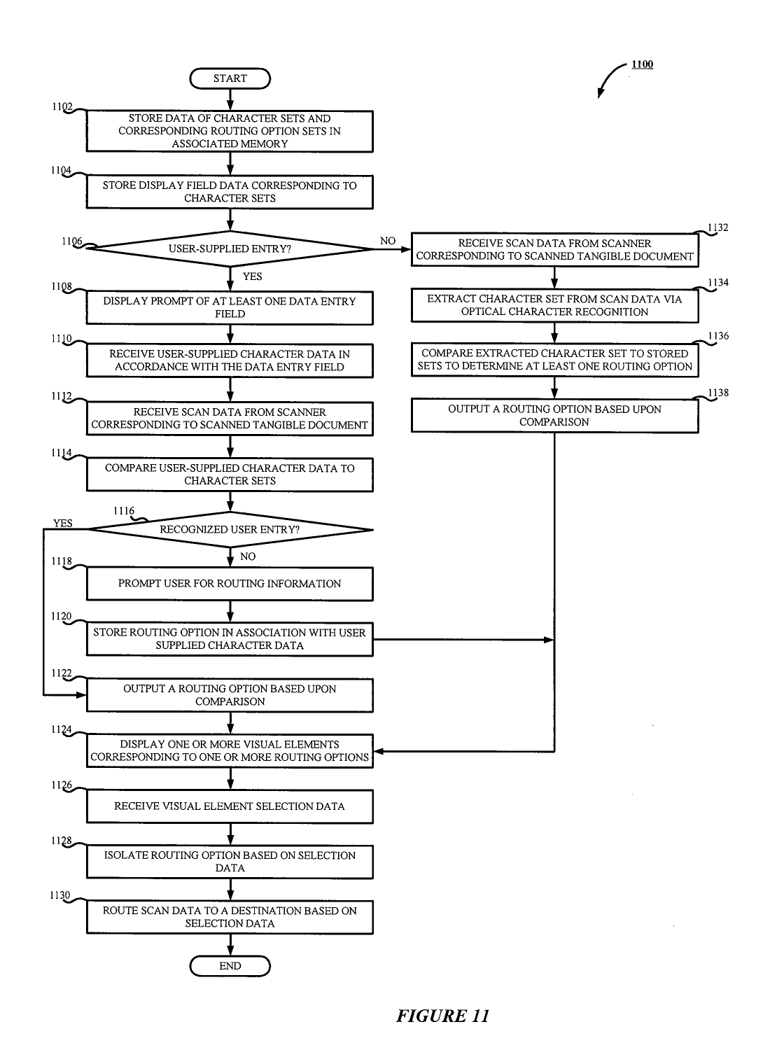

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11. Turning now to FIG. 10, there is shown a flowchart 1000 illustrating an intelligent routing assistant method for scan files, operable on a digital computer including a processor in accordance with one embodiment of the subject application. Beginning at step 1002, scan data is received from an associated scanner of a scan of a tangible document. At step 1004, character data is extracted from the received scan data via optical character recognition.

Data is then stored in an associated memory at step 1006, which data corresponds to a plurality of preselected character sets, with each character set associated with at least one of multiple available routing option sets. According to one embodiment of the subject application, each routing option set includes one or more data routing options associatively stored with the respective set in the memory. At step 1008, extracted character data is compared to the character sets so as to output at least one corresponding routing option. One or more visual elements are then displayed on an associated display at step 1010, the one or more visual elements preferably corresponding to the one or more routing options. Selection data is then received at step 1012 corresponding to at least one displayed visual element selected via user input from the associated user. At least one selected routing option received from the associated user is then isolated at step 1014. Thereafter, at step 1016, the scan data is routed to at least one destination based upon the selection data received from the associated user.

Referring now to FIG. 11, there is shown a flowchart 1100 illustrating an intelligent routing assistant method for scan files, operable on a digital computer including a processor in accordance with one embodiment of the subject application. It will become apparent to the skilled artisan that reference made herein to a digital computer having an associated processor is capable of corresponding to any suitable electronic device known in the art including, for example and without limitation, the controller 108 associated with the document processing device 104, the administrative device 120, or the like. Reference made hereinafter to the digital computer is therefore made with respect to the controller 108 or the administrative device 120 interchangeably for example purposes only.

The methodology of FIG. 11 begins at step 1102, whereupon preselected character sets and corresponding routing option sets are stored in the data storage device 110 associated with the document processing device. According to one embodiment of the subject application, the preselected character sets include a transaction number, user identifier, license number, telephone number, address, customer number, product type, service type, date, document type, and the like. Preferably, each routing set includes at least one associated routing option corresponding to a destination associated therewith. It will be understood by those skilled in the art that suitable destinations include, for example and without limitation, a file storage area, a facsimile transmission, a copy, an e-mail transmission, a print output, and the like.

At step 1104, the data storage device 1104 further stores display field data corresponding to stored preselected character data sets. It will be appreciated by those skilled in the art that the data stored on the data storage device 110 is capable of originating via administrative action at the server 114, via the administrative device 120, or other such device in data communication with the document processing device 104 via the computer network 102. The skilled artisan will further appreciate that such data is also capable of being locally uploaded to the document processing device 104 via a portable data device, received via a data communication (e.g. e-mail, ftp, or the like), and the like. It will also be appreciated that such settings are capable of being propagated amongst a plurality of document processing devices (not shown) on a given network 102 for which the administrator is responsible, e.g. all document processing devices associated with a particular company, customer account, department, institution, and the like.

A determination is then made at step 1106 whether user-supplied input of character set data is desired. That is, whether the user is to supply information relating to the preselected character set associated with a given scanning operation of the document processing device 104. Upon a positive determination at step 1106, operations proceed to step 1108, whereupon a prompt of at least one data entry field is displayed to the associated user via the user interface 106. In accordance with one embodiment of the subject application, the prompt is suitably displayed via an associated graphical user interface associated with the user interface 106. The skilled artisan will appreciate that suitable data entry fields include, for example and without limitation, fields requesting user-supplied character data such as a telephone number, an account number, an e-mail address, a document type, a facsimile number, and the like.

User-supplied character data is then received from the associated user at step 1110 in accordance with the displayed data entry field via the user interface 106. Scan data is then received from a scanner component of the document processing device 104 corresponding to a scanned tangible document at step 1112. At step 1114, the controller 108 or other suitable component associated with the document processing device 104 compares the user-supplied character data to the character sets stored on the associated data storage device 110. It will be appreciated by those skilled in the art that while reference is made herein to the controller 108 performing the comparison at step 1114, the server 114 is also capable of being employed to perform the storage and comparison, so as to alleviate processing burdens on the document processing device 104.

A determination is then made at step 1116 whether the user-supplied character data corresponds to any stored character sets. When it is determined at step 1116 that the user-supplied character data is not recognized, flow proceeds to step 1118. At step 1118, the user is prompted to supply a routing option associated with the scan data. It will be appreciated by those skilled in the art that suitable routing options include, for example and without limitation, storage in a selected folder, association with a particular account number, communication to a selected destination address (email or facsimile) and the like. The routing options selected by the user is then stored on the associated data storage 110 at step 1120 in association with the user-supplied character data so as to enable future operations to recognize the character data as a character set from scanned documents. Thus, the skilled artisan will appreciate that the controller 108 or other suitable component associated with the document processing device 104 is thereafter able to learn/add to the database of recognized character sets independent of an administrator supplying new sets. Operations then proceed to step 1124 as discussed in greater detail below.

Upon a determination at step 1116 that the user-supplied character data is a recognized entry, operations proceed to step 1122, whereupon a routing option is then output by the controller 108 corresponding to the results of the comparison performed at step 1114. It will be appreciated by those skilled in the art that such a routing option corresponds to a destination of the associated scanned tangible document, e.g. a file storage area, a facsimile transmission, a copy, an e-mail transmission, a print output, and the like. Operations then proceed to step 1124 as discussed below.

Returning to step 1106, when it is determined that no user-supplied character entry is received, flow proceeds to step 1132. At step 1132, scan data corresponding to a scanned tangible document is received from a scanner associated with the document processing device 104. Character set data is then extracted from the scan data via optical character recognition by the controller 108 or other suitable component associated with the document processing device 104 at step 1134. The skilled artisan will appreciate that such character data extracted from the scan data includes, for example and without limitation, a telephone number, a document type, a transaction number, user identifier, license number, telephone number, address, customer number, product type, service type, date, or other such information printed on the scanned tangible document. The extracted character set is then compared to character set data stored on the data storage device 110 at step 1136 so as to determine at least one routing option associated with the extracted character set, i.e. the scanned tangible document. One or more routing options are then output by the controller 108 or other suitable component associated with the document processing device 104 at step 1138 based upon the results of the comparison at step 1136.

After output of the comparison at steps 1122 or 1138, or after storage of the new routing option supplied by the user at step 1120, flow progresses to step 1124, whereupon one or more visual elements corresponding to the one or more routing options are displayed on the user interface 106, or other suitable displaying device associated with the document processing device 104. Preferably, the user is presented via a graphical user interface with several possible routing options, i.e. destinations, based upon, for example and without limitation, the type of document, a transaction number, a user identifier, a service type, a product type, a customer number, a date, a license number, or the like. In accordance with one embodiment of the subject application, the visual elements generated via the user interface 106 includes, for example and without limitation, indicia representative of an individual icon corresponding to each routing option, i.e. different icons for a scan to secure storage and scan to user home folder, textual descriptions of routing options, and the like. The skilled artisan will appreciate that any other suitable indicia are also capable of being generated to indicate routing options and the use of an icon above is intended only for example purposes.

At step 1126, the controller 108 or other suitable component associated with the document processing device 104 receives, via the user interface 106, selection data of at least one displayed visual element corresponding to a routing option selected by the associated user. That is, the user selects a desired destination from among those associated visual elements displayed on the graphical user interface of the user interface 106. The controller 108 or other suitable component associated with the document processing device 104 then isolates a routing option, e.g. destination, of the scanned tangible document based upon the selection data received from the user at step 1128. Thereafter, at step 1130, the scan data is routed to a destination based upon the selection data. For example, the scanned document is routed to network storage on the server 114, to local storage 110, printed as a copy by the document processing device 104, converted to another image format (.PDF, .JPEG, .TIFF, or the like), or other such destination as will be appreciated by those skilled in the art.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. An intelligent routing assistant system for scan files, operable on a digital computer including a processor, and comprising:
a scan input operable to receive scan data from a scan of an associated tangible document;
an optical character recognition system operable to extract character data from received scan data;
a memory including data corresponding to a plurality of preselected character sets, each character set being associated with at least one routing option set of a plurality thereof, each routing option set including at least one data routing option;
a comparator operable to compare extracted character data to the plurality of character sets so as to output at least one routing option corresponding thereto;
a display operable to display at least one visual element corresponding to the at least one routing option;
a user input operable to receive selection data corresponding to the at least one displayed element so as to isolate at least one selected routing option received from an associated user; and
a router operable to route the scan data to at least one destination in accordance with received selection data.

2. The system of claim 1 further comprising:
the memory further including display field data corresponding to the plurality of character sets;
the display further operable to prompt to prompt the associated user with at least one data entry field;
the user input further operable to receive user-supplied character data in accordance with the at least one data entry field; and
wherein the comparator is further operable to compare user-supplied character data to the plurality of character sets so as to output the at least one routing option corresponding thereto.

3. The system of claim 2 wherein the preselected character sets include data corresponding to at least one category from the set comprising transaction number, user identifier, license number, telephone number, address, customer number, product type, service type, date, and document type.

4. The system of claim 1 wherein the destination includes at least one of a storage to a selected file storage area, a facsimile transmission, a copy, an e-mail transmission, and a print output.

5. The system of claim 2 wherein the destination includes at least one of a storage to a selected file storage area, a facsimile transmission, a copy, an e-mail transmission, and a print output.

6. The system of claim 5 wherein the user-supplied character data includes at least one of a telephone number, account number and e-mail address.

7. An intelligent routing assistant method for scan files, operable on a digital computer including a processor, and comprising the steps of:
receiving scan data from a scan of an associated tangible document from an associated scanner;
extracting, via optical character recognition, character data from received scan data;
storing data corresponding to a plurality of preselected character sets in an associated memory, each character set being associated with at least one routing option set of a plurality thereof, each routing option set including at least one data routing option stored associatively therewith;
comparing extracted character data to the plurality of character sets so as to output at least one routing option corresponding thereto;
displaying at least one visual element corresponding to the at least one routing option on an associated display;
receiving selection data corresponding to the at least one displayed visual element from an associated user via a user input;
isolating at least one selected routing option received from the associated user; and
routing the scan data to at least one destination in accordance with received selection data.

8. The method of claim 7 further comprising the steps of:
storing display field data corresponding to the plurality of character sets;
displaying a prompt the associated user corresponding to at least one data entry field;
receiving user-supplied character data in accordance with the at least one data entry field; and
comparing user-supplied character data to the plurality of character sets so as to output the at least one routing option corresponding thereto.

9. The method of claim 8 wherein the preselected character sets include data corresponding to at least one category from the set comprising, transaction number, user identifier, license number, telephone number, address, customer number, product type, service type, date, and document type.

10. The method of claim 7 wherein the destination includes at least one of a storage to a selected file storage area, a facsimile transmission, a copy, an e-mail transmission, and a print output.

11. The method of claim 8 wherein the destination includes at least one of a storage to a selected file storage area, a facsimile transmission, a copy, an e-mail transmission, and a print output.

12. The method of claim 11 wherein the user-supplied character data includes at least one of a telephone number, account number, and e-mail address.

13. An intelligent routing assistant system for scan files, operable on a digital computer including a processor, and comprising:
means adapted for receiving scan data from a scan of an associated tangible document from an associated scanner;
an optical character recognition means adapted for extracting character data from received scan data;
a memory for storing data corresponding to a plurality of preselected character sets, each character set being associated with at least one routing option set of a plurality thereof, each routing option set including at least one data routing option stored associatively therewith;
a comparison means for comparing extracted character data to the plurality of character sets so as to output at least one routing option corresponding thereto;
a display means adapted for displaying at least one visual element corresponding to the at least one routing option;
an input means for receiving selection data corresponding to the at least one displayed visual element;
means adapted for isolating at least one selected routing option received from an associated user; and
a routing means for routing the scan data to at least one destination in accordance with received selection data.

14. The system of claim 13 further comprising:
the memory further including means adapted for storing display field data corresponding to the plurality of character sets;
the display means further including means adapted for displaying a prompt the associated user corresponding to at least one data entry field;
the input means including means adapted for receiving user-supplied character data in accordance, with the at least one data entry field; and
wherein the comparison means includes means adapted for comparing user-supplied character data to the plurality of character sets so as to output the at least one routing option corresponding thereto.

15. The system of claim 14 wherein the preselected character sets include data corresponding to at least one category from the set comprising, transaction number, user identifier, license number, telephone number, address, customer number, product type, service type, date, and document type.

16. The system of claim 13 wherein the destination includes at least one of a storage to a selected file storage area, a facsimile transmission, a copy, an e-mail transmission, and a print output.

17. The system of claim 14 wherein the destination includes at least one of a storage to a selected file storage area, a facsimile transmission, a copy, an e-mail transmission, and a print output.

18. The system of claim 17 wherein the user-supplied character data includes at least one of a telephone number, account number, and e-mail address.
